(19) United States
(12) Patent Application Publication
(10) Pub. No.: US 2013/0213918 A1
(43) Pub. Date: Aug. 22, 2013

(54) Shelving, Furniture, and Display Apparatus

(71) Applicant: Madix, Inc., Terrell, TX (US)

(72) Inventors: Don Richard DOYLE, JR., Auburn, AL (US); Steven Jay KRAMER, Heath, TX (US)

(21) Appl. No.: 13/766,343

(22) Filed: Feb. 13, 2013

Related U.S. Application Data
(60) Provisional application No. 61/598,077, filed on Feb. 13, 2012.

(51) Int. Cl. F16M 11/00; A47B 3/06; A47F 5/00

(52) U.S. Cl. CPC F16M 11/00; A47F 5/0018; A47B 3/06
USPC 211/187; 248/218.4; 108/157.17

(57) ABSTRACT

A shelving, furniture, and display apparatus and system with components having a hook with at least one horizontally extending flange which engages a support. Supports having slots that operate with the hook designs. Slots may be designed to accept hooks with at least one horizontally extending flange on the distal end and hooks with only a vertical distal end. The shelving, furniture, and display system based on modular components that are connected together to form the finished article.

### CROSS-REFERENCE TO RELATED APPLICATION

This application claims the benefit of priority from U.S. Provisional Application No. 61/598,077 filed on Feb. 13, 2012.

### FIELD OF THE INVENTION

This invention relates to shelving, furniture, and display apparatus and systems based on modular components that are connected together to form the finished article. More specifically, embodiments relate to shelving for use in retail and other environments, other furniture, and display systems.

### BACKGROUND

In the shelving art, components comprising support members and brackets with hooks that engage in slots in the support members are used. An example of the use of such components is a retail shelf system. A simple shelf may require only a pair of vertical support members with spaced apart openings that receive one or more hooks located at one end of a bracket. In a conventional form of support member the openings are vertically aligned, rectangular slots. The hooks include vertically disposed distal portions dimensional to allow their insertion through the slots and an intermediate portion of reduced vertical dimension connecting the distal portion to the bracket. In use, the distal end is inserted into the slot in a horizontal direction and the hook then moved vertically to engage the distal portion with the margins of the slot and hold the hook on the support.

In order to allow a variety of different shelving assemblies to be constructed using the support and bracket system, a support may be employed which is rectangular in horizontal cross-sections and comprises four spaced apart vertical surfaces forming the sides of the rectangle. Arrays of slots to receive hooks are provided in two or more of the surfaces. In prior art systems, the slots are the conventional aligned rectangles as described above.

### SUMMARY

The present disclosure provides an improved support for shelving, displays, or modular furniture. The modular systems for shelving, displays, and furniture referred to herein include apparatus such as retail shelving, hangers, display boards and cases, tables, and other items.

Some embodiments of the present disclosure provide a support for a modular system comprising four surfaces disposed in an essentially rectangular juxtaposition, at least two of the surfaces being provided with a longitudinal array of spaced slots, the slots being shaped to receive and engage a bracket hook which has horizontally extending portions at a distal end wherein, when the bracket hook is inserted in the slot and engaged, the horizontal portion of the hook contacts the margins of the opening in the support.

The present disclosure includes some embodiments which provide versatility in creating shelving, displays, or furniture. For example, some embodiments include a support having slots in all four sides. The use of the four sided slotting on the support allows components of shelving, displays, and/or other furniture to be assembled in a multitude of configurations using a common kit of parts.

Some embodiments of the present disclosure provide a support for a modular system which is essentially circular and comprises, at least one longitudinal array of spaced slots, the slots being shaped to receive a bracket hook which has a distal end with vertical and horizontal extending portions wherein, when the bracket hook is inserted in the slot, the horizontal portion of the hook contacts the margins of the opening in the support.

Embodiments of the present disclosure may include combinations of one or more modular components which employ slots and/or bracket hooks as described herein.

### BRIEF SUMMARY OF THE DRAWINGS

Embodiments will now be described, by way of example only, with references to the accompanying drawings in which:

FIG. 1 shows an embodiment of a shelf unit employing supports of the disclosure;

FIG. 2a shows an enlarged detailed view of embodiments of the support and bracket of the disclosure before the bracket is connected to the support;

FIG. 2b shows an enlarged detailed view of the support and bracket of FIG. 2a when assembled;

FIG. 3 shows an embodiment of a table that can be constructed using the support and bracket of FIGS. 2a and 2b;

FIG. 4 shows an embodiment of a hanger system employing supports of the disclosure; and

FIG. 5 shows top down view of an embodiment of engaged modular components of the disclosure.

### DETAILED DESCRIPTION

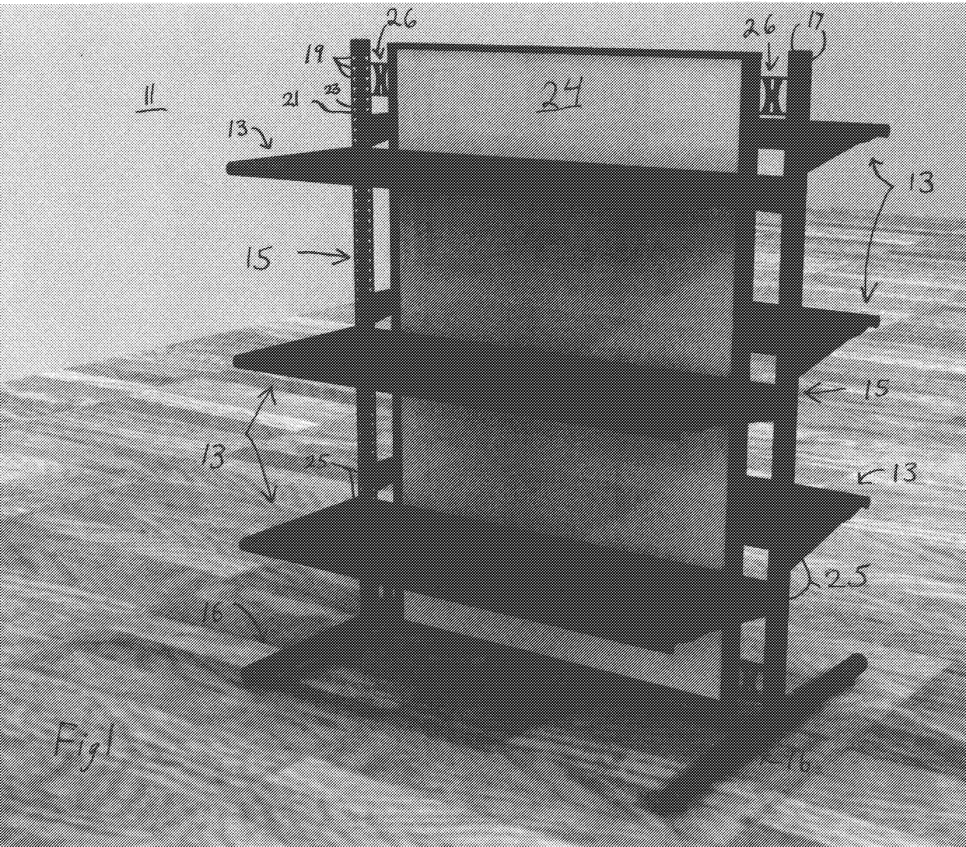

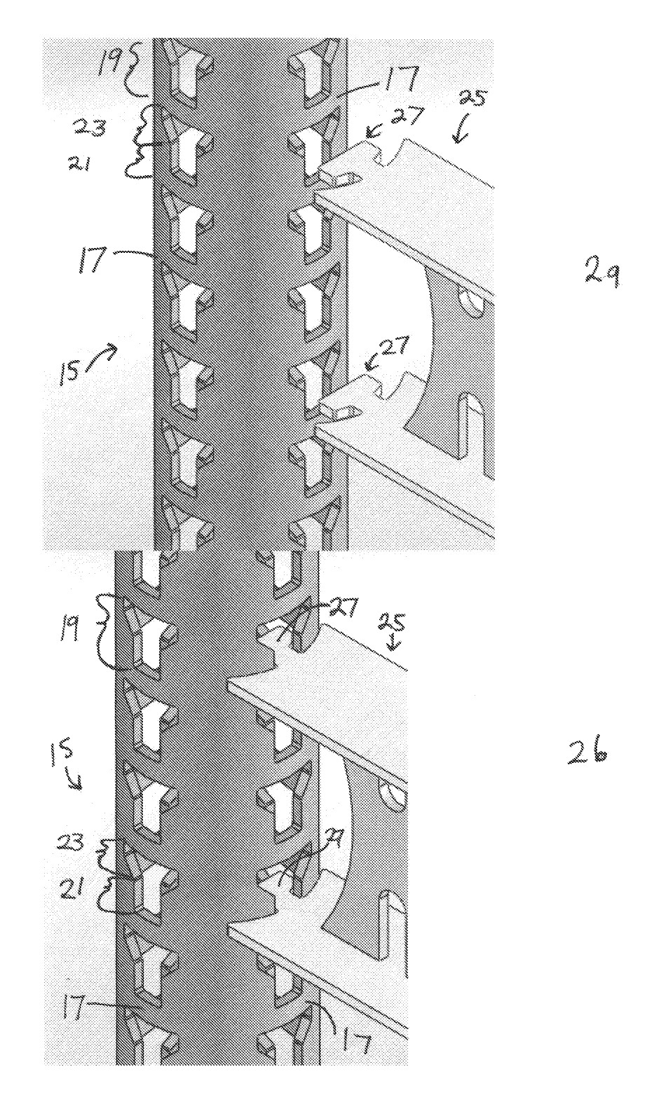

Referring first to FIG. 1, a shelving system 11 comprises six essentially horizontal shelves 13 mounted on two vertical supports 15 mounted on horizontal base members 16. In FIG. 1 three of the shelves 13 are mounted to one side of the support 15 and three to the opposite side of those supports 15. It will be appreciated that the number and placement of shelves 13 may vary. Each support 15 comprises four surfaces 17 arranged in a rectangle. Each surface 17 includes a spaced array of openings 19 (shown in more detail in FIGS. 2a and 2b). Each opening 19 includes a vertical slot portion 21 and a horizontally wider upper portion 23 communicating with the vertical slot portion 21 (shown in more detail in FIGS. 2a and 2b).

As seen in FIG. 1, the shelves 13 have at their ends brackets 25 which, at the rear of the end brackets 25 have hooks 27 that are engaged in the openings 19 to secure the shelf 13 on the support.

In this embodiment, wall 24 in between the backs of shelves 13 and in between the supports 15. Wall 24 includes four wall brackets 26 which secure the wall 24 to the supports 15. In this embodiment, wall 24 is not connected to shelves 13, but may abut the rear of one or more of shelves 13. In some embodiments, one or more shelves 13 may be further connected to wall 24. It will be appreciated that components other than shelves 13 may be attached to the supports 15 in addition to wall 24. It will further be appreciated that wall 24 may include information, advertising, and/or other content. For example, wall 24 may display a product layout to assist the user in knowing where to place products on the shelves. The product layout may further include advertising for the selected product.

FIGS. 2a and 2b show in detail the configuration of openings 19 in the supports 15 and of the hooks 27 that engage in the slots. As described above, each opening 19 includes a vertical slot portion 21 and a horizontally wider upper portion 23 communicating with the vertical slot portion 21. Hook 27 includes a horizontally wide portion that engages the horizontally wider upper portion 23 of the opening 19. In some embodiments, hook 27 may also include additional portions that may be inserted into openings 19 and engage supports 15. For example, hook 27 may further include a vertical distal end under the horizontally wider portion.

As will be appreciated, unlike the converted slot hook shape, the horizontally wider upper portion 23 of the opening 19 and of the distal end of the hook 27 gives a larger area of contact between the bracket and the support than the conventional configuration and provides greater support for horizontal components carried by the vertical supports 15.

In the embodiment shown in FIGS. 2a and 2b, bracket 25 included two vertically displaced hooks 27. The use of two vertically displaced hooks 27 increases the structural support provided by bracket 25 by increasing the area of contact and spreading the load distribution of the bracket 25 across a larger area. It will be appreciated that other embodiments of the brackets 25 may use one or more hooks 27. The design and selection of brackets 25 may be based in part upon the expected use and load bearing requirements.

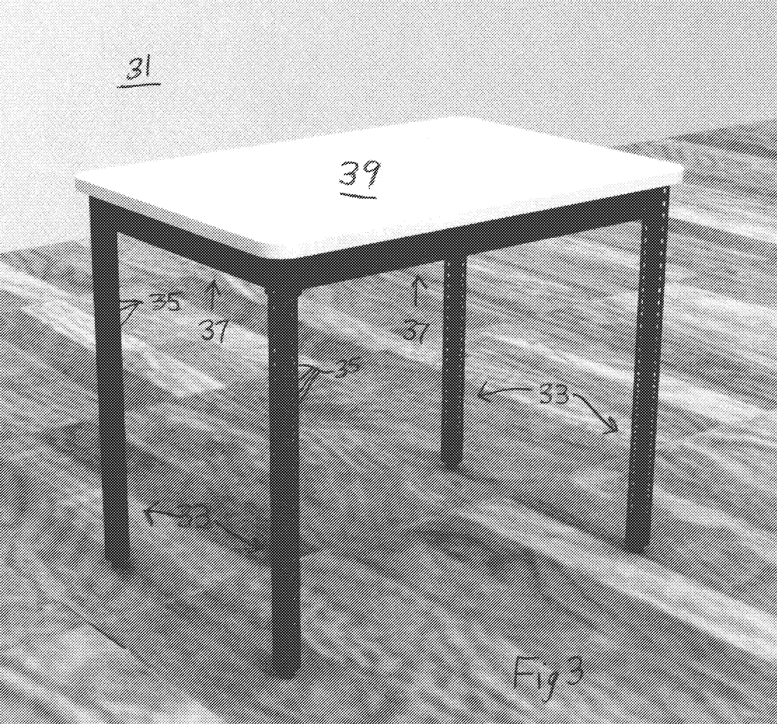

FIG. 3 shows a table 31 constructed using the supports of the present disclosure as the legs 33 of the table 31, illustrating the versatility of the disclosed system. In this embodiment, the table 31 comprises four legs 33 each formed by a four sided support similar to the support 15 described with respect to FIGS. 1 and 2. In this embodiment, each side of the leg 33 is provided with a vertical array of openings 35 substantially similar to the openings 19 described with respect to FIGS. 1 and 2. In some embodiments, openings 35 may only be located near the top of legs 33 and/or in a vertical array along only two adjacent sides of legs 33. The legs 33 are connected at their upper ends to the ends of four horizontal support members 37. At each end of each support member 37 is a hook dimensioned to connect into the openings 35 near the top of each leg 33. It will be appreciated that each support member 37 may include one or more hooks that connect into the openings 35. A top 39 for the table 31 is disposed on the support members 37.

In some embodiments, additional surfaces and/or compartments may be built into the table 31. For example, two additional horizontal support members 37 may be connected between opposite pairs of legs 33 such that an additional surface (like top 39) may be supported at a lower level than top 39.

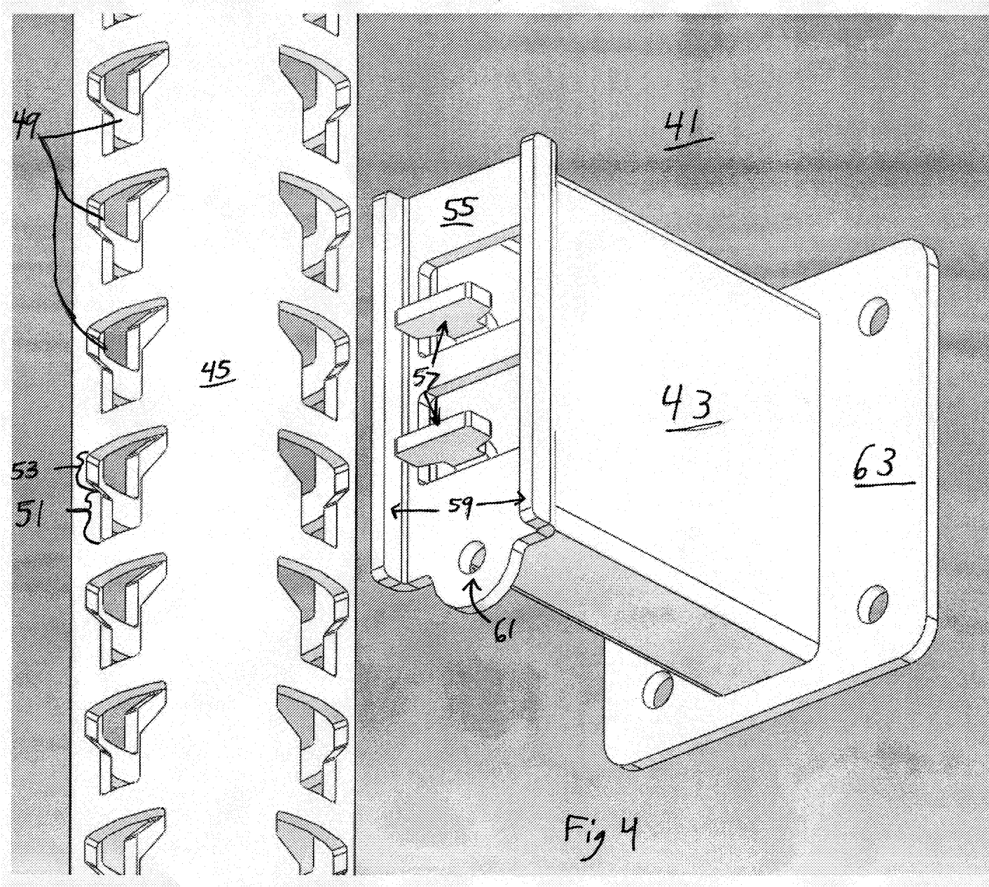

FIG. 4 depicts an embodiment of a hanger system 41 comprising an essentially horizontal hanger bar 43 which may be mounted on one or more vertical supports 45. It will be appreciated that the number and placement of hanger bars 43 may vary. In this embodiment, each support 45 is generally round in shape, and includes four vertically spaced arrays of openings 49. It will be appreciated that the number and arrangement of openings 49, and/or arrays of openings 49 may vary. Each opening 49 includes a vertical slot portion 51 and a horizontally wider upper portion 53 communicating with the vertical slot portion 51.

As seen in FIG. 4, the hanger bar 43 has at one end bracket 55 and at the other end plate 63. Bracket 55 includes hooks 57 that may be inserted into and engage the openings 49 and secure the hanger bar 43 on the support 45. In this embodiment, bracket 55 also includes extensions 59 which may provide additional contact area against the rounded support 45 in this embodiment. This embodiment further includes tab 61 with a hole at the bottom of bracket 55. In some embodiments, tab 61 may provide be used to provide additional support through the use of a bolt, pin, screw, or other extension that may be inserted and/or secured to support 45. Tab 61 may be used as a guide in other embodiments.

Hooks 57 include horizontally wide portions which engage the horizontally wider upper portion 53 of the opening 49. In some embodiments, hooks 57 may also include additional portions that may be inserted into openings 49 and engage supports 45. For example, hook 57 may further include a vertical distal end under the horizontally wider portion. As will be appreciated, unlike the converted slot hook shape, the horizontally wider upper portion 53 of the opening 49 and of the distal end of the hook 57 gives a larger area of contact between the bracket and the support than the conventional configuration and provides greater support for horizontal components carried by the vertical supports 45.

In the embodiment shown, bracket 55 included two vertically displaced hooks 57. The use of two vertically displaced hooks 57 increases the structural support provided by bracket 55 by increasing the area of contact and spreading the load distribution of the bracket 55 across a larger area. It will be appreciated that other embodiments of the brackets 55 may use one or more hooks 57. The design and selection of brackets 55 may be based in part upon the expected use and load bearing requirements.

In some embodiments, plate 63 located at the other end of hanger bar 43 prevents one or more items from sliding off hanger bar 43. In some embodiments, plate 63 is utilized to provide information, advertising, and/or other content. In some embodiments, plate 63 may be used to attach hanger bar 43 to a wall, another hanger, or another apparatus. For example, plate 63 may include four holes whereby four bolts, screws, and/or other connectors may be used to secure plate 63 to a wall.

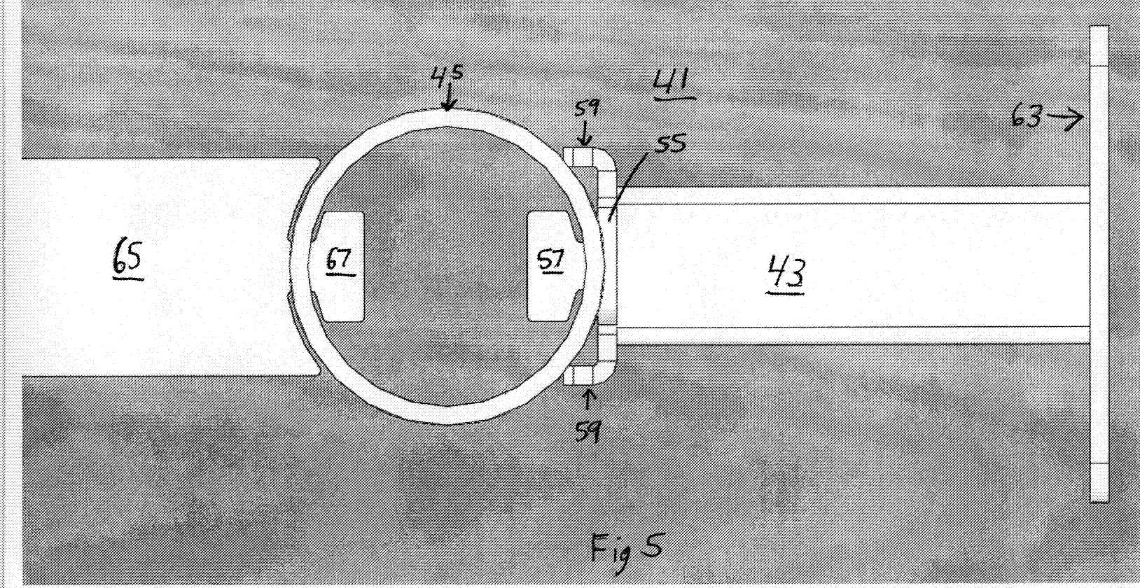

FIG. 5 depicts a top view of a round support 45 attached to hanger system 41 on one side and an alternative attachment 65 on the opposite side. In this embodiment, support 45 includes at least two arrays of openings on opposite sides wherein hooks 57 and 67 may be inserted and engaged with support 45. Hanger system 41 includes elements described above with regard to FIG. 4. As seen in FIG. 5, in this embodiment bracket 55 and extensions 59 thereof provide three points of contact with the round support 45 when hanger system 41 is inserted in support 45.

The alternative attachment 65 includes hook 67 which is shown inserted in support 45. In this embodiment, alternative attachment 65 also includes a curved end with hook 67 extending from a central area of the curve. The curve of the end is designed to compliment the curve of support 45 to provide additional contact area and sufficient structural support for alternative attachment 65. It will be appreciated that alternative attachment 65 may comprise any type of attachable component, including shelves, hanger bars, table top supports, drawer rails, advertising or content display, supports, and/or other components. One skilled in the art will recognize that the design of the brackets used in conjunction with the hooks may vary and remain within the scope and spirit of the disclosure.

In some embodiments, hanger bar 43 may include brackets 55 at each end and not include a plate 63. In such embodiments, hanger bar 43 may be disposed between two supports 45. In some embodiments, hanger bar 43 is used to display informational, advertising, and/or other content. In other embodiments, hanger bar 43 is used to display and/or hold hanging clothes. It will be appreciated that some embodiments may include sections with hanger bars 43 and others with shelves 13 as described above.

It will further be appreciated that additional designs of tables and other types of shelving, furniture, and display apparatus may be constructed using variations on these components and/or additional components which are compatible with the hooks and opening disclosed herein. For example, stools, chairs, steps, clothing racks, drawers, and other furniture may be constructed.

1. A modular system comprising one or more uprights and one or more components with at least one bracket adapted to be supported by the uprights by releasable engagement of at least one rearwardly facing hook of the brackets with at least one slot in the uprights, wherein the hook is horizontally extended and wherein the slot in the upright is dimensioned and arranged to receive the distal end of said hook.

2. A modular system as claimed in claim 1 wherein the upright comprises four sides and at least one said slot is located in each of said four sides.

3. A modular system as claimed in claim 1 wherein the slot in the upright is T-shaped.

4. A modular system as claimed in claim 1 wherein said components are arranged to create a table.

5. A modular system as claimed in claim 1 wherein said components are arranged to create a shelving structure.

6. A modular system as claimed in claim 1 wherein said components are arranged to create an item hanging structure.

7. A modular system as claimed in claim 1 wherein said components are arranged to create a display structure.

8. A modular system as claimed in claim 1 wherein said components are arranged to create a seat.

9. A modular system as claimed in claim 1 wherein said components are arranged to create a drawer.

10. A modular system as claimed in claim 1 wherein said brackets comprise at least two said hooks which are vertically spaced such that each of said at least two hooks may enter a separate said slot of said upright and simultaneously engage said upright.

11. A modular system as claimed in claim 1 comprising:
a first upright having at least two sets of said slots;
a second upright having at least two sets of said slots;
a connecting component with said brackets, wherein said connecting component is spaced between said first upright and said second upright and in releasable engagement with one set of slots in said first upright and one set of slots in said second upright; and
a second component with at least one of said brackets releasable engaged with at least one set of slots in said first upright or said second upright.

12. A modular system as claimed in claim 11 wherein said connecting component is at least one of a wall structure, a display structure, a hanger structure, and a connecting bar.

13. A modular system as claimed in claim 11 wherein said second component is at least one of a shelf, a wall structure, a display structure, and a hanger structure.

14. A table made of modular components comprising one or more uprights and one or more support members with brackets adapted to be supported by the uprights by releasable engagement of rearwardly facing hooks of the brackets with slots in the uprights, wherein the hook is horizontally extended and wherein the upright has slots dimensioned and arranged to receive the distal end of said hook, and a surface on top of said support members.

15. A shelving structure made of modular components comprising one or more uprights and one or more shelves with brackets adapted to be supported by the uprights by releasable engagement of rearwardly facing hooks of the brackets with slots in the uprights, wherein the hook is horizontally extended and wherein the upright has slots dimensioned and arranged to receive the distal end of said hook.

16. A shelving structure of claim 15 comprising two said uprights with a wall structure between said uprights, wherein the wall structure includes brackets adapted to be supported by the uprights by releasable engagement of said hooks of the brackets with said slots in the uprights.

17. A shelving structure of claim 16 comprising at least one second component with at least one of said brackets, and wherein at least one of said uprights further supports said at least one second component by releasable engagement of said hooks of the brackets with said slots in the uprights.

18. A shelving structure of claim 17 comprising two said uprights with a hanger structure between said uprights, wherein the hanger structure includes brackets adapted to be supported by the uprights by releasable engagement of said hooks of the brackets with said slots in the uprights.

19. A shelving structure of claim 18 comprising at least one second component with at least one of said brackets, and wherein at least one of said uprights further supports said at least one second component by releasable engagement of said hooks of the brackets with said slots in the uprights.
